(19) United States
(12) Patent Application Publication
(10) Pub. No.: US 2012/0234270 A1
(43) Pub. Date: Sep. 20, 2012

(54) ENGINE ASSEMBLY INCLUDING CRANKSHAFT FOR V4 ARRANGEMENT

(75) Inventors: EDWARD J. KEATING, ORTONVILLE, MI (US); ROBERT S. MCALPINE, LAKE ORION, MI (US); AKRAM R. ZAHDEH, ROCHESTER HILLS, MI (US); HATEM ZAKARIA ORBAN, AUBURN HILLS, MI (US)

(73) Assignee: GM GLOBAL TECHNOLOGY OPERATIONS LLC, DETROIT, MI (US)

(21) Appl. No.: 13/050,293

(22) Filed: Mar. 17, 2011

(51) Int. Cl. F02B 75/22; F16C 3/06

(52) U.S. Cl. 123/54.4; 74/595

(57) ABSTRACT

An engine assembly may include an engine structure and a crankshaft. The engine structure may include an engine block defining a first bank of cylinders defining two cylinders and a second bank of cylinders defining two cylinders forming a V4 arrangement. The crankshaft may include a first crank pin, a second crank pin, a third crank pin and a fourth crank. The fourth crank pin may be rotationally offset from the first crank pin by a first angle of less than two hundred and seventy degrees in the rotational direction of the crankshaft. The second and third crank pins may be located rotationally between the first crank pin and the fourth crank pin in the rotational direction.

### FIELD

The present disclosure relates to engine crankshafts.

### BACKGROUND

This section provides background information related to the present disclosure which is not necessarily prior art.

Four cylinder engines may typically incorporate the use of one or more balance shafts to accommodate an imbalance created by the crankshaft, connecting rod and piston assembly. Additionally, operating a four cylinder engine in a mode where one of the cylinders is temporarily disabled for three cylinder operation may typically result in a firing period that is different than four cylinder operation.

### SUMMARY

An engine assembly may include an engine structure and a crankshaft. The engine structure may include an engine block defining a first bank of cylinders defining two cylinders and a second bank of cylinders defining two cylinders forming a V4 arrangement. The crankshaft may include a first crank pin, a second crank pin, a third crank pin and a fourth crank pin. The fourth crank pin may be rotationally offset from the first crank pin by a first angle of less than two hundred and seventy degrees in the rotational direction of the crankshaft. The second and third crank pins may be located rotationally between the first crank pin and the fourth crank pin in the rotational direction.

In another arrangement, an engine assembly may include an engine structure, a crankshaft, and pistons. The engine structure may include an engine block defining a first bank of cylinders defining two cylinders and a second bank of cylinders defining two cylinders forming a V4 arrangement having a bank angle of sixty degrees. The crankshaft may be rotationally supported on the engine structure and may include a first crank pin, a second crank pin, a third crank pin and a fourth crank pin. The second crank pin may be rotationally offset from the first crank pin in a rotational direction of the crankshaft by sixty degrees, the third crank pin may be rotationally offset from the second crank pin in the rotational direction by sixty degrees, and the fourth crank pin may be rotationally offset from the third crank pin in the rotational direction by sixty degrees. A first piston may be coupled to the first crank pin and located in the first cylinder, a second piston may be coupled to the second crank pin and located in the second cylinder, a third piston may be coupled to the third crank pin and located in the third cylinder, and a fourth piston may be coupled to the fourth crank pin and located in the fourth cylinder. The engine assembly may define a firing order including the second cylinder and the third cylinder having combustion events at the same time.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only and are not intended to limit the scope of the present disclosure in any way.

FIG. 1 is a schematic illustration of an engine assembly according to the present disclosure;

FIG. 2 is a schematic section view of the engine assembly of FIG. 1;

FIG. 3 is a side view of a crankshaft included in the engine assembly of FIG. 1; and

FIG. 4 is a schematic illustration of crank pin orientation on the crankshaft of FIG. 3.

Corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

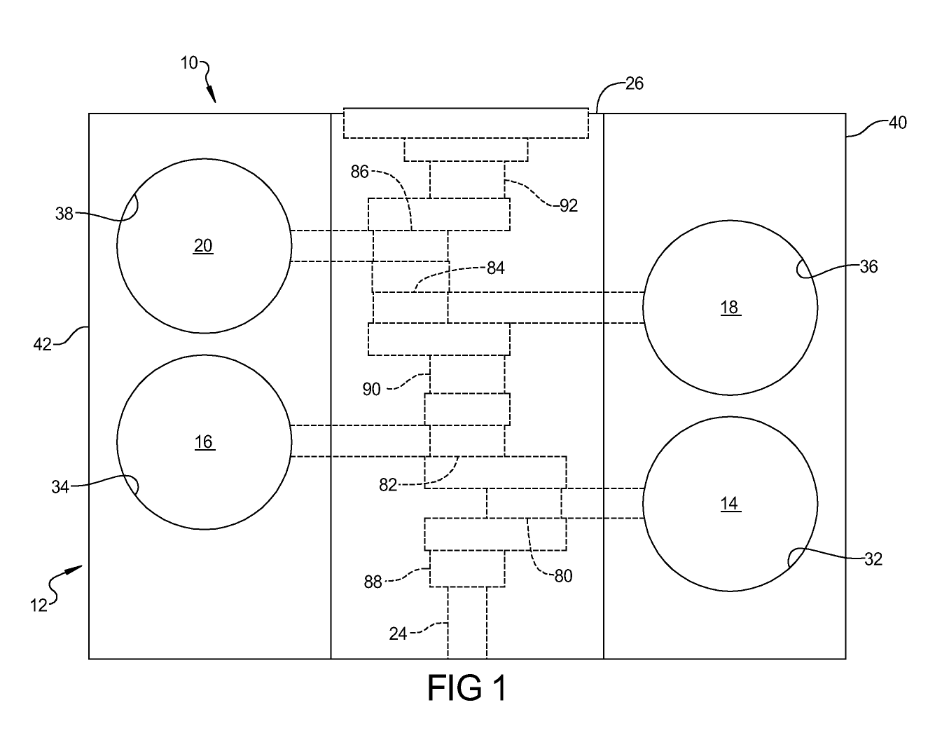

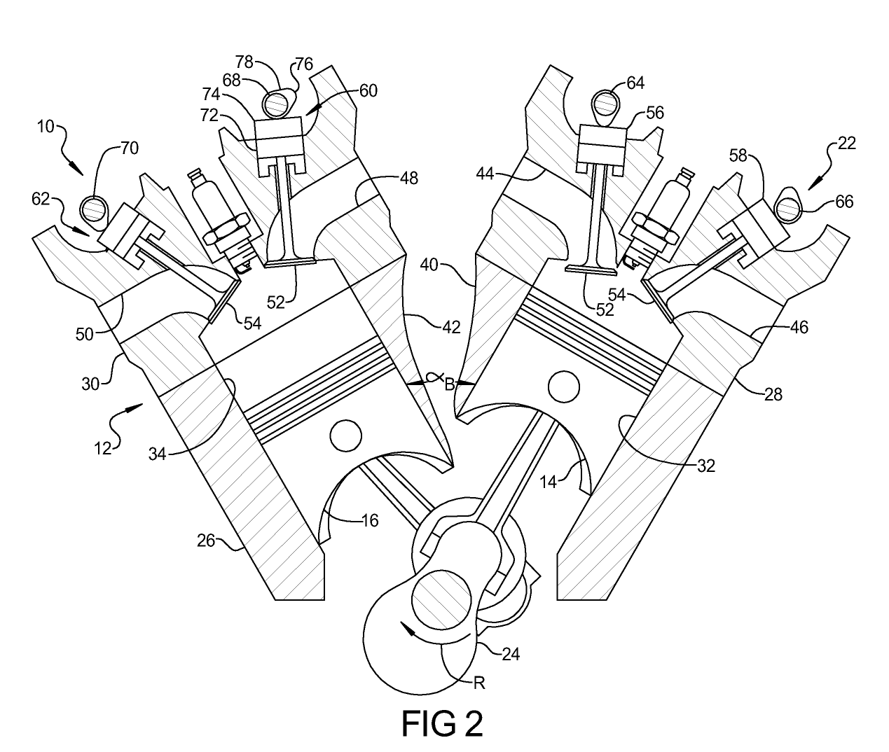

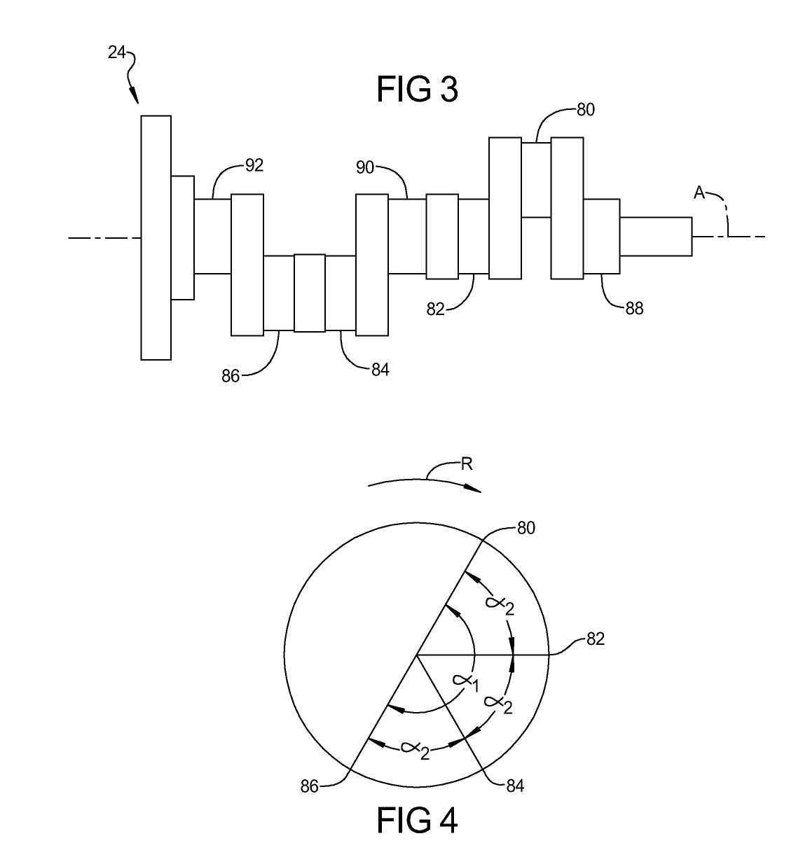

An engine assembly 10 is illustrated in FIGS. 1 and 2 and may include an engine structure 12, first, second, third and fourth pistons 14, 16, 18, 20, a valvetrain assembly 22 and a crankshaft 24. The engine structure 12 may include an engine block 26, a first cylinder head 28 and a second cylinder head 30. The engine structure 12 may define first, second, third and fourth cylinders 32, 34, 36, 38 in the engine block 26. In the present non-limiting example, the engine block 26 includes a first bank of cylinders 40 defining two cylinders and a second bank of cylinders 42 defining two cylinders.

The first and third cylinders 32, 36 may be defined in the first bank 40 and the second and fourth cylinders 34, 38 may be defined in the second bank 42. A bank angle (α_{B}) may be defined between the first and second banks of cylinders 40, 42 forming a V4 arrangement. The first piston 14 may be located in the first cylinder 32, the second piston 16 may be located in the second cylinder 34, the third piston 18 may be located in the third cylinder 36, and the fourth piston 20 may be located in the fourth cylinder 38.

As seen in FIG. 2, the first cylinder head 28 may define intake ports 44 and exhaust ports 46 in communication with the first and third cylinders 32, 36. Similarly, the second cylinder head 30 may define intake ports 48 and exhaust ports 50 in communication with the second and fourth cylinders 34, 38. The section view illustrated in FIG. 2 includes the first and second cylinders 32, 34. For simplicity, the port arrangement and valvetrain corresponding to the third and fourth cylinders 36, 38 will not be described in detail with the understanding that the description relative to the first and second cylinders 32, 34 applies equally as indicated below.

The valvetrain assembly 22 may include intake valves 52 located in the intake ports 44, 48 and exhaust valves 54 located in the exhaust ports 46, 50, first, second, third and fourth valve lift mechanisms 56, 58, 60, 62 and camshafts 64, 66, 68, 70. While illustrated as an overhead cam arrangement, it is understood that the present disclosure is not limited to overhead cam arrangements and applies equally to a variety of other engine configurations including, but not limited to, cam-in-block (or pushrod) arrangements.

The first camshaft 64 may be engaged with the first valve lift mechanism 56 to displace the intake valve 52 between open and closed positions, the second camshaft 66 may be engaged with the second valve lift mechanism 58 to displace the exhaust valve 54 between open and closed positions, the third camshaft 68 may be engaged with the third valve lift mechanism 60 to displace the intake valve 52 between open and closed positions, and the fourth camshaft 70 may be engaged with the fourth valve lift mechanism 62 to displace the exhaust valve 54 between open and closed positions.

In the present non-limiting example, the third valve lift mechanism 60 may be operable in a first mode and a second mode. More specifically, the third valve lift mechanism 60 may include a first member 72 engaged with the intake valve 52 and a second member 74 engaged with the third camshaft 68. In the first mode, the first and second members 72, 74 may be fixed for displacement with one another such that the intake valve 52 is displaced to an open position when a peak 76 of a cam lobe 78 on the third camshaft 68 engages the third valve lift mechanism 60. In the second mode, the first and second members 72, 74 may be displaceable relative to one another such that the intake valve 52 remains in a closed position when the peak 76 of the cam lobe 78 engages the third valve lift mechanism 60. Alternatively, the third cylinder 36 may include valve lift mechanisms operable in the first and second modes.

The crankshaft 24 may be rotationally supported on the engine structure 12 by the engine block 26 and may include a first crank pin 80, a second crank pin 82, a third crank pin 84 and a fourth crank pin 86 each located radially outward from a rotational axis (A) of the crankshaft 24. The first piston 14 may be coupled to the first crank pin 80, the second piston 16 may be coupled to the second crank pin 82, the third piston 18 may be coupled to the third crank pin 84 and the fourth piston 20 may be coupled to the fourth crank pin 86. The first crank pin 80 may be located at a first axial end of the crankshaft 24 and the fourth crank pin 86 may be located at a second axial end of the crankshaft 24. The second crank pin 82 may be located axially between the first crank pin 80 and the fourth crank pin 86. The third crank pin 84 may be located axially between the second crank pin 82 and the fourth crank pin 86.

The crankshaft 24 may include a first bearing journal 88 at the first axial end of the crankshaft 24, a second bearing journal 90 axially between the second and third crank pins 82, 84, and a third bearing journal 92 at the second axial end of the crankshaft 24. Therefore, the engine structure 12 may have only three main bearings rather than the five typically used in an inline four cylinder arrangement.

The first, second, third, and fourth crank pins 80, 82, 84, 86 may be rotationally offset from one another. In the present non-limiting example, the fourth crank pin 86 is rotationally offset from the first crank pin 80 by a first angle (α₁) of less than two hundred and seventy degrees in a rotational direction (R) of the crankshaft 24. The second crank pin 82 and the third crank pin 84 may be located rotationally between the first crank pin 80 and the fourth crank pin 86 in the rotational direction (R) of the crankshaft 24. In the present non-limiting example, the first angle (α₁) is one hundred and eighty degrees.

The third crank pin 84 may be rotationally offset from the second crank pin 82 by a second angle (α₂) of less than ninety degrees in the rotational direction (R) of the crankshaft 24. More specifically, the first, second, third, and fourth crank pins 80, 82, 84, 86 may each be rotationally offset from one another by the second angle (α₂). For example, the second crank pin 82 may be rotationally offset from the first crank pin 80 by the second angle (α₂) in the rotational direction (R) of the crankshaft 24, the third crank pin 84 may be rotationally offset from the second crank pin 82 by the second angle (α₂) in the rotational direction (R) of the crankshaft 24, and the fourth crank pin 86 may be rotationally offset from the third crank pin 84 by the second angle (α₂) in the rotational direction (R) of the crankshaft 24. The second angle (α₂) may be equal to the bank angle (α_{B}). In the present non-limiting example, the bank angle (α_{B}) and the second angle (α₂) are each sixty degrees.

The arrangement of the crankshaft 24 may generally provide for primary balance in the engine assembly 10 through the use of crankshaft counterweighting and without the use of balance shafts. Engine primary balance is achieved when the forces and moments occurring at the first harmonic of crankshaft rotation created by the crankshaft, connecting rod and piston assembly are balanced.

The arrangement of the crankshaft 24 also provides for a common firing interval during both engine operation including firing all four cylinders 32, 34, 36, 38 every seven hundred and twenty degrees of crankshaft rotation and engine operation including only firing the first, third and fourth cylinders 32, 36, 38 every seven hundred and twenty degrees of crankshaft rotation (i.e., operating the third valve lift mechanism 60 from the second cylinder 34 in the second mode). For example, the engine assembly 10 may define a first firing interval when the third valve lift mechanism 60 is operated in the first mode and a second firing interval equal to the first firing interval when the third valve lift mechanism 60 is operated in the second mode.

The first and second firing intervals may each include a combustion event every two hundred and forty degrees of crankshaft rotation. Therefore, an even firing interval may be provided both when the third valve lift mechanism 60 is operated in the first mode and when the third valve lift mechanism 60 is operated in the second mode. In the present non-limiting example, this arrangement is made possible by firing the second cylinder 34 at the same time as the third cylinder 36 (i.e., the second cylinder 34 having a combustion event at the same time as the third cylinder 36). The firing order may include firing the first cylinder 32, then firing the second and third cylinders 34, 36 at the same time, and then firing the fourth cylinder 38.

When the third valve lift mechanism 60 is operated in the first mode, the combustion cycle may include the first cylinder 32 being fired, the second and third cylinders 34, 36 being fired two hundred and forty degrees of crankshaft rotation after the first cylinder 32 is fired, and the fourth cylinder 38 being fired two hundred and forty degrees of crankshaft rotation after the second and third cylinders 34, 36 are fired. The cycle repeats two hundred and forty degrees of crankshaft rotation after the fourth cylinder 38 is fired.

When the third valve lift mechanism 60 is operated in the second mode, the combustion cycle may include the first cylinder 32 being fired, the third cylinder 36 being fired (without the second cylinder 34) two hundred and forty degrees of crankshaft rotation after the first cylinder 32 is fired, and the fourth cylinder 38 being fired two hundred and forty degrees of crankshaft rotation after the third cylinder 36 is fired. The cycle repeats two hundred and forty degrees of crankshaft rotation after the fourth cylinder 38 is fired. A similar arrangement may be provided by firing the second cylinder 34 and not the third cylinder 36.

What is claimed is:

1. A V4 engine crankshaft comprising:
a first crank pin defined on the crankshaft;
a second crank pin defined on the crankshaft;
a third crank pin defined on the crankshaft; and
a fourth crank pin defined on the crankshaft and rotationally offset from the first crank pin by a first angle of less than 270 degrees in a rotational direction of the crankshaft and the second crank pin and the third crank pin being located rotationally between the first crank pin and the fourth crank pin in the rotational direction of the crankshaft.

2. The V4 engine crankshaft of claim 1, wherein the third crank pin is rotationally offset from the second crank pin by a second angle equal to a bank angle defined between a first bank of cylinders and a second bank of cylinders defined in a V4 engine block housing the crankshaft.

3. The V4 engine crankshaft of claim 2, wherein the third crank pin is engaged with a piston in the first bank of cylinders and the second crank pin is engaged with a piston in the second bank of cylinders.

4. The V4 engine crankshaft of claim 3, wherein the first crank pin is located at a first axial end of the crankshaft and the fourth crank pin is located at a second axial end of the crankshaft.

5. The V4 engine crankshaft of claim 2, wherein the second angle is less than 90 degrees.

6. The V4 engine crankshaft of claim 1, wherein the first angle is 180 degrees.

7. The V4 engine crankshaft of claim 6, wherein the third crank pin is rotationally offset from the second crank pin by 60 degrees.

8. The V4 engine crankshaft of claim 1, wherein the second crank pin is located axially between the first crank pin and the fourth crank pin and the third crank pin is located axially between the second crank pin and the fourth crank pin, the second crank pin is rotationally offset from the first crank pin by 60 degrees in the rotational direction of the crankshaft, the third crank pin is rotationally offset from the second crank pin by 60 degrees in the rotational direction of the crankshaft and the fourth crank pin is rotationally offset from the third crank pin by 60 degrees in the rotational direction of the crankshaft.

9. An engine assembly comprising:
an engine structure including an engine block defining a first bank of cylinders including two cylinders and a second bank of cylinders including two cylinders forming a V4 arrangement; and
a crankshaft rotationally supported on the engine structure and including a first crank pin, a second crank pin, a third crank and a fourth crank pin rotationally offset from the first crank pin by a first angle of less than 270 degrees in a rotational direction of the crankshaft, the second crank pin and the third crank pin being located rotationally between the first crank pin and the fourth crank pin in the rotational direction of the crankshaft.

10. The engine assembly of claim 9, wherein the third crank pin is rotationally offset from the second crank pin by a second angle equal to a bank angle defined between the first bank of cylinders and the second bank of cylinders.

11. The engine assembly of claim 10, further comprising a first piston coupled to the first crank pin and located in a first cylinder defined in the first bank of cylinders, a second piston coupled to the second crank pin and located in a second cylinder defined in the second bank of cylinders, a third piston coupled to the third crank pin and located in a third cylinder defined in the first bank of cylinders and a fourth piston coupled to the fourth crank pin and located in a fourth cylinder defined in the second bank of cylinders.

12. The engine assembly of claim 11, wherein the first crank pin is located at a first axial end of the crankshaft and the fourth crank pin is located at a second axial end of the crankshaft.

13. The engine assembly of claim 10, wherein the second angle is less than 90 degrees.

14. The engine assembly of claim 9, further comprising a first piston coupled to the first crank pin and located in a first cylinder defined in the first bank of cylinders, a second piston coupled to the second crank pin and located in a second cylinder defined in the second bank of cylinders, a third piston coupled to the third crank pin and located in a third cylinder defined in the first bank of cylinders and a fourth piston coupled to the fourth crank pin and located in a fourth cylinder defined in the second bank of cylinders, the engine assembly defining a firing order including the second cylinder and the third cylinder having a combustion event at the same time.

15. The engine assembly of claim 14, further comprising a cylinder head located on the engine block and defining a port in communication with the second cylinder, a valve located within the port, a valve lift mechanism engaged with the valve and a camshaft engaged with the valve lift mechanism, the valve lift mechanism being operable in a first mode and a second mode, the first mode including the valve being displaced to an open position when the valve lift mechanism is engaged by a peak of a cam lobe on the camshaft and the second mode including the valve remaining in a closed position when the valve lift mechanism is engaged by the peak of the cam lobe.

16. The engine assembly of claim 15, wherein the engine assembly defines a first firing interval when the valve lift mechanism is operated in the first mode and a second firing interval equal to the first firing interval when the valve lift mechanism is operated in the second mode.

17. The engine assembly of claim 9, wherein the first angle is 180 degrees.

18. The engine assembly of claim 17, wherein the third crank pin is rotationally offset from the second crank pin by 60 degrees.

19. The engine assembly of claim 9, wherein the second crank pin is located axially between the first crank pin and the fourth crank pin and the third crank pin is located axially between the second crank pin and the fourth crank pin, the second crank pin is rotationally offset from the first crank pin by 60 degrees in the rotational direction of the crankshaft, the third crank pin is rotationally offset from the second crank pin by 60 degrees in the rotational direction of the crankshaft and the fourth crank pin is rotationally offset from the third crank pin by 60 degrees in the rotational direction of the crankshaft.

20. An engine assembly comprising:
an engine structure including an engine block defining a first bank of cylinders including two cylinders and a second bank of cylinders including two cylinders forming a V4 arrangement having a bank angle of 60 degrees;
a crankshaft rotationally supported on the engine structure and including a first crank pin, a second crank pin rotationally offset from the first crank pin in a rotational direction of the crankshaft by 60 degrees, a third crank pin rotationally offset from the second crank pin in the rotational direction by 60 degrees, and a fourth crank pin rotationally offset from the third crank pin in the rotational direction by 60 degrees; and
a first piston coupled to the first crank pin and located in a first cylinder defined in the first bank of cylinders, a second piston coupled to the second crank pin and located in a second cylinder defined in the second bank of cylinders, a third piston coupled to the third crank pin and located in a third cylinder defined in the first bank of cylinders, and a fourth piston coupled to the fourth crank pin and located in a fourth cylinder defined in the second bank of cylinders, the engine assembly defining a firing order including the second cylinder and the third cylinder having combustion events at the same time.
